(19) United States
(12) Patent Application Publication
(10) Pub. No.: US 2019/0334990 A1
(43) Pub. Date: Oct. 31, 2019

(54) Distributed State Machine for High Availability of Non-Volatile Memory in Cluster Based Computing Systems

(71) Applicant: EXTEN Technologies, Inc., Austin, TX (US)

(72) Inventors: Michael Enz, Fargo, SD (US); Ashwin Kamath, Cedar Park, TX (US); Rukhsana Ansari, San Jose, CA (US)

(21) Appl. No.: 16/395,738

(22) Filed: Apr. 26, 2019

Related U.S. Application Data
(60) Provisional application No. 62/663,760, filed on Apr. 27, 2018.

(51) Int. Cl. H04L 29/08; G06F 3/06; G06F 9/54

(52) U.S. Cl. CPC H04L 67/1097; G06F 3/067; H04L 12/56; G06F 3/0629; G06F 9/546; G06F 3/0617

(57) ABSTRACT

Highly available storage clusters, including NVMeoF storage clusters are disclosed. Such high availability storage cluster may have increased sized, higher availability and decreased individual hardware requirements

### RELATED APPLICATION(S)

This application claims a benefit of priority under 35 U.S.C. § 119(e) from the filing date of U.S. Provisional Application No. 62/663,760, filed on Apr. 27, 2018, entitled “Distributed State Machine for High Availability of Non-Volatile Memory in Cluster Based Computing Systems,” by Enz et al, the entire contents of which are incorporated herein in their entirety for all purposes.

### TECHNICAL FIELD

This disclosure relates to the field of data storage. More particularly, this disclosure relates to storage networks. Even more particularly, this disclosure relates to embodiments of dynamically reconfigurable high-availability storage clusters.

### BACKGROUND

Businesses, governmental organizations and other entities are increasingly using larger and larger volumes of data necessary in their daily operations. This data represents a significant resource for these entities. To store and provide rapid and reliable access to this data, high-availability (HA) storage clusters may be utilized. An HA storage cluster (or just HA cluster) is composed of a group of computer systems (or nodes) coupled via a communication medium, where each of the nodes is coupled to hardware resources, including the storage resources (e.g., drives or storage media) of the cluster. The drives or other storage resources of the cluster are almost always non-volatile memory; commonly flash memory in the form of a solid-state drive (SSD).

The nodes of the cluster may present a set of services or interfaces (or otherwise handle commands or accesses requests) for accessing the drives or other resources of the cluster. The drives may therefore be accessed through the nodes of the clusters to store or otherwise access data on the drives. Such clusters may allow at least one node to completely fail, and the remaining nodes take over the hardware resources to maintain availability of the cluster services. These types of clusters are usually referred to as “high-availability” (HA) clusters.

Non-Volatile Memory Express (NVMe or NVME) or Non-Volatile Memory Host Controller Interface Specification (NVMHCIS), an open logical device interface specification for accessing non-volatile storage media, has been designed from the ground up to capitalize on the low latency and internal parallelism of flash-based storage devices.

What is desired, therefore, are highly available storage clusters, including NVMeoF storage clusters, with increased sized and higher availability and decreased individual hardware (e.g., drive hardware) requirements.

### SUMMARY

To those ends, among others, embodiments as disclosed herein may include a storage cluster including a set of nodes that coordinate ownership of storage resources such as drives, groups of drives, volumes allocated from drives, virtualized storage, etc. between and across the nodes. Specifically, embodiments may include nodes that coordinate which node in the cluster owns each drive. As the ownership is transferred between nodes in the cluster, the embodiments may dynamically and adaptively (re)configure a switch or a virtual switch partition to effectively configure the switch such that the drives are in communication with the appropriate nodes. In this manner, the node count in the cluster may be increased, an N-to-N redundancy model for node failures may be achieved along with multi-path cluster communications and fine-grained failover of individual resources (e.g., instead of entire nodes).

Specifically, embodiments may model or implement virtual abstractions of storage resources of a cluster in a quorum based resource management system such that the storage resources may be managed by the quorum based system. The storage resources may, for example, be abstracted or modeled as generalized resources to be managed by the quorum based resource management system.

Modules to implement the underlying hardware configuration needed to accomplish the management tasks (e.g., the reprogramming of a switch to reassign the storage resources) can then be accomplished using these models. In this manner, the quorum based resource management system may manage storage resources, including hardware, utilizing management rules, while the implementation of the hardware (or software) programming needed to accomplish management tasks may be separated from the quorum based resource management system.

In one embodiment, a high availability storage cluster, comprises a switch; a set of storage resources coupled to a set of hosts and coupled to the switch via a first network and a set of nodes coupled via a second network to the switch, each node including an HA module thereon. The HA modules at each of the set of nodes may cooperate to maintain a state for the HA storage cluster.

In one embodiment, each HA module at each node maintains the state of the HA cluster by communicating with each of the other HA modules to synchronize the state maintained at each of the other HA modules with the state maintained at the HA module at that node and includes a state machine for the HA cluster, wherein the state includes an association between each of the resources and a corresponding one of the set of nodes.

The HA module (e.g., at a first node) may be adapted for monitoring resources of the HA storage cluster, detecting a failure in a resource of a storage cluster and accessing the state maintained at the first node to determine that the switch is programmed such that the failed resource is assigned to a partition of the switch associated with the failed resource. The HA module can determine a second node to which the failed resource should be assigned based on the state machine of the HA module at the first node and the state maintained at the first node, and reprogram the switch such that the switch is reconfigured to assign the storage resource and the second node to a same virtual switch partition.

In a particular embodiment, wherein the resources include the switch, the set of nodes, the set of storage resources, a volume, a LUN or a network path.

In some embodiment, monitoring resources includes attempting to access the resources at a time interval or communicating a heartbeat message between each HA module.

In specific embodiment, a failure is a bandwidth or data rate associated with the resource falling below a certain threshold.

In yet another embodiment, the first network and the second network are the same network.

In still other embodiments, the switch is a PCI Express switch.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a diagrammatic representation of a storage network including one embodiment of a storage cluster.

FIG. 2 is a diagrammatic representation of one embodiment of a high-availability (HA) module.

FIG. 3 is a diagrammatic representation of one embodiment of a storage cluster.

FIG. 4 is a diagrammatic representation of one embodiment of a storage cluster.

FIG. 5 is a diagrammatic representation of one embodiment of a storage cluster.

### DETAILED DESCRIPTION

The invention and the various features and advantageous details thereof are explained more fully with reference to the nonlimiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

Before discussing specific embodiments, some context may be useful. Businesses, governmental organizations and other entities are increasingly using larger and larger volumes of data necessary in their daily operations. This data represents a significant resource for these entities. To store and provide rapid and reliable access to this data, high-availability storage clusters may be utilized. A high-availability storage cluster (or just high-availability cluster) is composed of a group of computer systems (or nodes) coupled via a communication medium, where each of the nodes is coupled to hardware resources, including the storage resources (e.g., drives or storage media) of the cluster. The drives or other storage resources of the cluster are almost always non-volatile memory; commonly flash memory in the form of a solid-state drive (SSD).

The nodes of the cluster may present a set of services or interfaces (or otherwise handle commands or accesses requests) for accessing the drives or other resources of the cluster. The drives may therefore be accessed through the nodes of the clusters to store or otherwise access data on the drives. Such clusters may allow at least one node to completely fail, and the remaining nodes take over the hardware resources to maintain availability of the cluster services. These types of clusters are usually referred to as “high-availability” (HA) clusters.

Non-Volatile Memory Express (NVMe or NVME) or Non-Volatile Memory Host Controller Interface Specification (NVMHCIS), an open logical device interface specification for accessing non-volatile storage media, has been designed from the ground up to capitalize on the low latency and internal parallelism of flash-based storage devices. Thus, in many instances, the nodes of a cluster are coupled to the storage resources over a communication medium through a Personal Computer Interface (PCI) Express (PCIe or PCIE) bus or switch and NVMe is used to communicate between the nodes and the storage resources. This communication medium may, for example, be a communication network such as Ethernet, Fibre Channel (FC) or InfiniBand. These types of storage clusters are often referred to as NVMe over Fabrics (NVMeoF or NVMEoF).

For NVMeoF storage appliances, the cluster is responsible for serving data from the drives to network attached client computers. As with other types of storage networks, NVMeoF storage nodes often require clustering for high-availability. Typical solutions have primitive failover capabilities that may only allow a single node in the cluster to fail. Other solutions may require specialized drives with multiple PCIe ports. Moreover, these traditional high-availability solutions for NVMe require multiple PCI Express ports in each drive. This increases the cost of the solution and limits the failover to a two node cluster.

Other solutions may utilize a virtually partitioned PCIe switch with single port drives. However, the failure detection and failover mechanisms tend to be very limited hardware processes that only support complete node failure (as opposed to individual resource failover) and a 1+1 or N+1 redundancy model. Those models tend to be insufficient for extremely high levels of reliability, since there is no redundancy for a particular node after a single failure.

More specifically, existing models for highly available NVMeoF servers may fall in two categories. One category requires dual ported NVMe drives that can connect to two separate nodes in the cluster. Either or both nodes may issue IO commands to the drives. During a failover event, one node must assume full control of the drive but this does not require any hardware reconfiguration. However, this model limits the cluster to two nodes since drives only support two ports. Additionally, this model adds cost to the drive to support dual ports.

Another high-availability category uses a single virtually partitioned PCI Express switch with two or more root nodes. Each node can utilize a subset of the devices. But a drive is only visible to one node at a time due to the switch partitioning. In this model, a failover requires a reprogramming of the virtual partition of the PCIe switch to move all of the drives on the failed node to an active node. Existing implementations of this model tend to use a few static configurations such as a simple two node cluster with three states (both active, or either node failed). Furthermore, the failover mechanism tends to be a global all-or-nothing event for the entire node, where all drives transition together.

What is desired, therefore, are highly available storage clusters, including NVMeoF storage clusters, with increased sized and higher availability and decreased individual hardware (e.g., drive hardware) requirements.

To those ends, among others, embodiments as disclosed herein may include a storage cluster including a set of nodes that coordinate ownership of storage resources such as drives, groups of drives, volumes allocated from drives, virtualized storage, etc. (referred to herein collectively and interchangeably as storage resources, drives or drive resources without loss of generality) between and across the nodes. Specifically, embodiments may include nodes that coordinate which node in the cluster owns each drive. As the ownership is transferred between nodes in the cluster, the embodiments may dynamically and adaptively (re)configure a switch (e.g., a PCI Express switch) or a virtual switch partition to effectively configure the switch such that the drives are in communication with the appropriate nodes. In this manner, the node count in the cluster may be increased, an N-to-N redundancy model for node failures may be achieved along with multi-path cluster communications, and fine-grained failover of individual resources (instead of entire nodes).

Specifically, embodiments may model or implement virtual abstractions of storage resources of a cluster in a quorum based resource management system such that the storage resources may be managed by the quorum based system. The storage resources may, for example, be abstracted or modeled as generalized resources to be managed by the quorum based resource management system.

Modules to implement the underlying hardware configuration needed to accomplish the management tasks (e.g., the reprogramming of a switch to reassign the storage resources) can then be accomplished using these models. In this manner, the quorum based resource management system may manage storage resources, including hardware, utilizing management rules, while the implementation of the hardware (or software) programming needed to accomplish management tasks may be separated from the quorum based resource management system.

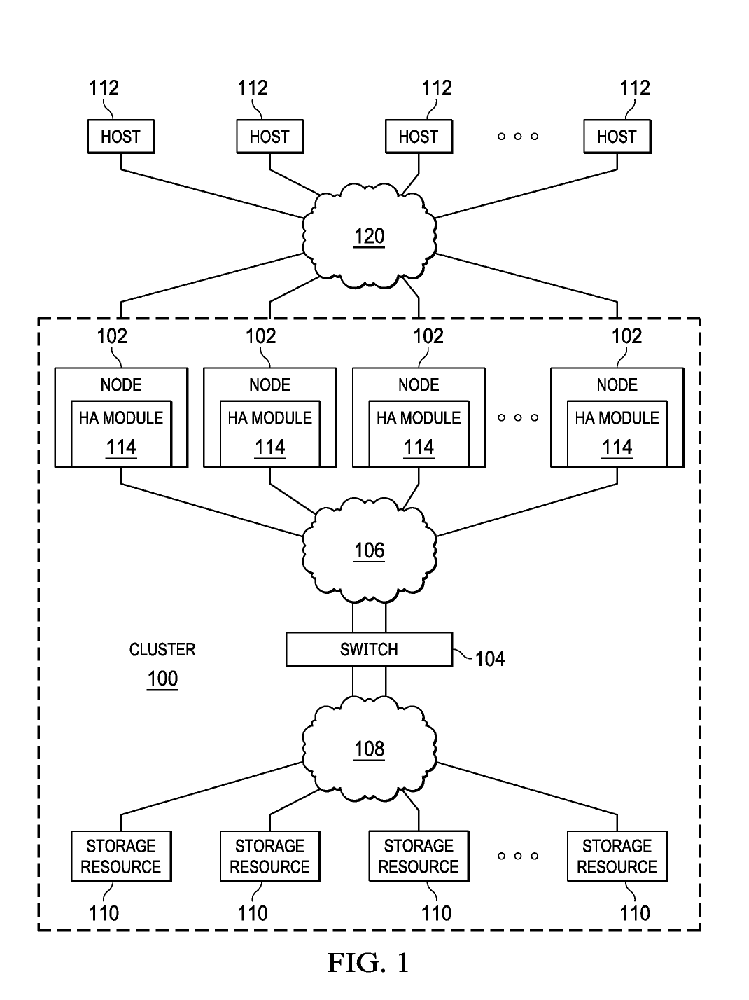

Moving now to FIG. 1, a general architecture for one embodiment of a high-availability storage cluster is depicted. According to one embodiment the cluster 100 includes a set of nodes 102 coupled to a switch 104 over a communication medium 106. The switch may be a PCIe switch as is known in the art or another type of switch. However, for ease of understanding the switch 104 may be referred to herein as PCIe switch without loss of generality. The set of nodes 102 are also coupled to one another through a communication medium, which may be the same as, or different than, the communication medium 106 or switch 104.

The switch 104 is coupled to a set of storage resources 110 over communication medium 108. These storage resources 110 may be drives (e.g., SSDs), volumes of drives, groups of drives, logical partitions or volumes of drives, or generally any logically separable storage entity. The communication mediums 106, 108 may be the same or different communication mediums and may include, for example, PCIe, Ethernet, InfiniBand, Fibre Channel, or another type of communication medium.

The switch 104 may be configurable such that storage resources 110 are associated with, or belong to, particular nodes 102. The configurability is sometimes referred to as switch partitioning. In particular, the switch 104 may be configured such that nodes 102 coupled to a particular port of the switch may be in a partition with zero or more storage resources 110. Examples of such switches 104 include PCIe switches such PES32NT24G2 PCI Express Switch by IDT or the Broadcom PEX8796.

When a storage resource 110 can be accessed through a particular node 102, this may be colloquially referred to as the node 102 “owning” or being “assigned” the storage resource 110 when they are in the same partition. Thus, cluster 100 can serve data from the storage resources 110 to hosts 112 coupled to the cluster 100 through communication medium 120 which again may include, PCIe, Ethernet, InfiniBand, Fibre Channel, or another type of communication medium. Hosts 112 issue requests to nodes 102, the nodes 102 implement the requests with respect to the storage resources 110 to access data in the storage resources 110. The request may be routed or directed to the appropriate node 102 of the partition to which a storage resource 110 associated with the request belongs, and the node 102 may implement the request with respect to the storage device 110 or the data thereon.

Each node 102 of the cluster 100 includes a high-availability module 114. The set of high-availability modules 114 may coordinate with one another to dynamically coordinate ownership of the storage resources 110 of the cluster 100 by dynamically reprogramming switch 104 based on the state of the cluster, including the nodes 102, storage resources 110 or switch 104 of the cluster 100.

According to embodiments, the high-availability modules 114 on each node 102 may communicate between the nodes 102 using the same network as the data transfers from the storage devices 110 to the hosts 112, or a different network. For example, the high-availability modules 114 may communicate in an out of band Ethernet network separate from the data transfers, a data path in band Converged Ethernet network shared with the data transfers, a data path in band Ethernet over InfiniBand network shared with the data transfers or a PCIe point-to-point or multicast messages via the switch 104. Other communication mediums are possible for communication between the high-availability modules and are fully contemplated herein.

The high-availability modules 114 may implement a distributed cluster state machine that monitors the state of the cluster 110 and dynamically reprograms switch 104 based on the state of the cluster 100 and the state machine. Each of the high-availability modules 114 may maintain a state of the cluster 100 where the state is synchronized between the high-availability modules 114. Moreover, the high-availability modules 114 may monitor the status of the resources in the cluster 100, including the other nodes 102, the switch 104, the storage resources 110, the communication mediums 106, 108 or other resources. This monitoring may occur by attempting to “touch” or otherwise access the switch 104 or storage resources 110, or utilizing a “heartbeat” message communicated between HA modules 114.

When a failure is detected in a resource in the cluster 100, the high-availability module 114 may reconfigure the cluster 100 according to the state machine to account for the failure of the resource.

For example, if a node 102 failure is detected, the high-availability module 114 may access the state machine to determine which storage resources 110 are associated with the failed node 102 (e.g., the storage resources 110 in a virtual switch partition associated with the failed node 102) and where (e.g. which nodes 102 or switch partition) to re-assign those storage resources 110. Based on this determination, the high-availability module 114 may re-program switch 104 to configure the switch 104 to re-assign those storage resources 110 to the appropriate node 102 or switch partition. By dynamically reprogramming the switch 104 to re-assign resources within the cluster, increased node count in the cluster 100 may be achieved, along with an N-to-N redundancy model for node failures, multi-path cluster communication and fine-grained failover of individual resources instead of entire nodes.

In another embodiment, the high-availability module 114 may reconfigure the cluster 100 according to the state machine to account for other aspects associated with a resource. For example, if bandwidth or data rate associated with a resource falls below a certain threshold level, the high-availability module 114 may access the state machine to determine where (e.g. which nodes 102 or switch partition) to re-assign those storage resources 110. Based on this determination, the high-availability module 114 may re-program switch 104 to configure the switch 104 to re-assign those storage resources 110 to the appropriate node 102 or switch partition to increase the data rate or increase overall performance of the cluster 100.

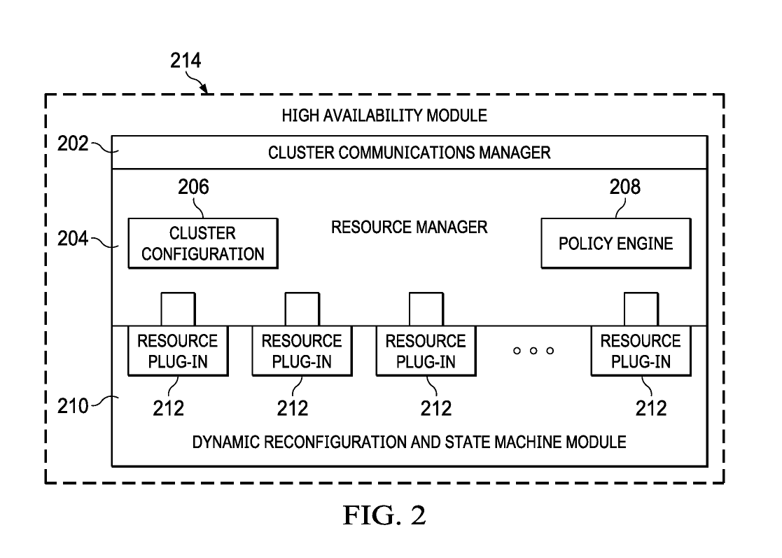

Turning to FIG. 2, one embodiment of an architecture for a high-availability module for use on nodes of a storage cluster is depicted. The high-availability module 214 may include a cluster communication manager 202. This cluster communication manager 202 may create a communication framework for the entire cluster to see a consistent set of ordered messages that may be transmitted over multiple different networks. The messages are delivered in the same sequence on each node in the cluster, allowing all nodes to remain consistent on cluster configuration changes.

This layer may also be responsible for maintaining cluster membership, where all nodes are constantly communicating with all other nodes to prove they are still functional. Any failure to receive a heartbeat notification may be detected by any other member of the cluster (e.g., the high-availability module 214 on another node of the cluster). Upon detection, the remaining nodes use the in-order communication network to mark the failed node offline. One example of a tool that may be utilized to employ a cluster communication manager or portions thereof is Corosync. Another tool that may be utilized is Linux HA—Heartbeat.

High-availability module 214 may also include a cluster resource manager 204 used to manage abstract resources in a cluster of computers. The resources may represent actual resources (either logical or physical) in the cluster. These resources may be started (or associated with) one or more nodes in the cluster. The resources are substantially constantly (e.g., at an interval) monitored to ensure they are operating correctly, for example, by checking for fatal crashes or deadlocks that prevent normal operation. If any failure is detected, the resource manager 204 uses a set of rules or priorities to attempt to resolve the problem. This would include options to restart the resource or move it to another node in the cluster. One example of a tool that may be utilized to employ a cluster resource manager 204 or portions thereof is Pacemaker. Other tools that may be utilized by the high-availability module 214 may include the cluster manager CMAN, the Resource Group Manager (RGManager) and the Open Service Availability Framework (OpenSAF). Other tools are possible and are fully contemplated herein.

The cluster (e.g., an NVMeoF cluster) requires understanding the underlying hardware platform. The information about the available programmable interfaces (such as partitioned PCIe switch models), drive locations (such as slots and PCIe switch port locations), and other behaviors are listed in a platform configuration file. That file is used to create the cluster.

In particular, the resource manager 204 may include a cluster configuration 206 and a policy engine 208. In one embodiment, the configuration 206 may allow the resource manager 204 and high-availability module 214 to understand the underlying hardware platform. The information about the available programmable interfaces (e.g., such as partitioned PCIe switch models), drive locations (such as slots and PCIe switch port locations), and other resources and behaviors are listed in the cluster configuration 206.

Accordingly, in one embodiment, the cluster configuration 206 may define the set of resources (e.g., logical or physical) of the cluster. This cluster configuration 206 can be synchronized across the high-availability modules 214 on each node of the cluster by the resource manager 204. The resources of the cluster may be the storage resources that are high-availability resources of the cluster. Here, such resources may be hardware resources or services, including storage resources, or software services. The resources may also include performance resources associated with the bandwidth or data rate of a storage resource, a node, the switch or the cluster generally.

The definition for a resource may include, for example, the name for a resource within the cluster, a class for the resource, a type of resource plug-in or agent to user for the resources and a provider for the resource plug-in. The definition of a resource may also include a priority associated with a resource, the preferred resource location, ordering (defining dependencies), resource fail counts, or other data pertaining to a resource. Thus, the cluster configuration 206 may include rules, expressions, constraints or policies (terms which will be utilized interchangeably herein) associated with each resource. For example, in a cluster, the configuration 206 may include a list of preferred nodes and associated drives. These rules may define a priority node list for every storage resource (e.g., drive) in the cluster.

Thus, the cluster configuration 206 may define storage resources, such as drives, groups of drives, partitions, volumes, logical unit numbers (LUNs), etc., and a state machine for determining, based on a status (or state) of the resources of the cluster, to which node these resources should be assigned. This state machine may also, in certain embodiments, include a current status of the cluster maintained by the cluster manager 204. By defining a resource in the resource manager 204 for storage resources, including hardware based storage resources such as drives, groups of drives, switches, etc., these hardware resources may be dynamically managed and re-configured utilizing an architecture that may have traditionally been used to manage deployed software applications.

In one embodiment, the configuration for the cluster includes the following information: Networking; IP address configuration for cluster management; Multicast or unicast communication setup; Global Policies; Resource start failure behavior; Failback Timeouts and Intervals—Minimum time before a failback after a failover event occurred, and the polling interval to determine if a failback may occur; Node Configuration; Network name for each node; Resources—The set of resources to manage, including the resource plug-in script to use; Dependencies—The colocation dependency of resources that must be on the same cluster node; Order—The start/stop order requirements for resources; Preferred Node—The weighted preference for hosting a resource on each node in the cluster; Instance Count—The number of each resource to create—e.g. one resource vs one resource on each node; Monitoring Intervals and Timeout; Failure Behaviors and Thresholds—Number of failures to trigger a restart or a resource move; Resource Specific Configuration and NVMe drive identifiers, such as GUID, PCI Slot number, and PCIe switch port number

Policy engine 208 may be adapted to determine, based on the cluster configuration and a current status of the cluster, to what node of the cluster each storage resource should be assigned. In particular, according to certain embodiments the policy engine 208 may determine a next state of the cluster based on the current state and the configuration. In some embodiments, the policy engine 208 may produces a transition graph containing a list of actions and dependencies.

HA module 214 also includes a dynamic reconfiguration and state machine module 210. The HA module 214 may include one or more resource plug-ins 212. Each resource plug-in 212 may correspond to a type of resource defined for the cluster in the cluster configuration 206. For example, resource plug-ins 212 may correspond to single port drives, dual port drives, load balanced single port drives or other types of storage resources.

Specifically, in certain embodiments, a resource plug-in 212 may present a set of interfaces associated with operations for a specific type of resource and implement the functionality of that interface or operations. Specifically, the resources plug-ins may offer the same or similar, set of interfaces and serve to implement operations for those interfaces on the corresponding type of interface. By abstracting the implementation of the interface for a particular type of resources the resource manager 204 is allowed to be agnostic about the type of resources being managed. This plug-in may be, for example, a resource agent that implements at least a start, stop and monitor interface.

Thus, in certain embodiments, a resource plug-in 212 may be responsible for starting, stopping, and monitoring a type of resource. These plug-ins 212 may be utilized and configured for managing the PCIe switch virtual partition programming based on calls received from the resource manager 204. Different variations of resource plug-ins may thus be used to modify the desired behavior of the storage cluster. Below are example resources and the functionality of a corresponding resource plug-in:

Partitioned Drive—This resource is responsible for reprogramming a PCIe switch to effectively move an NVMe drive from one node to another node.

Performance Drive Monitor—This resource monitors both the health and performance of an NVMe drive. It may report a “fake” failure to cause the drive to failover for load balancing of storage traffic across nodes. Alternatively, it may reprogram the resource to node preference to force movement of the resource between cluster nodes.

Network Monitor—This resource monitors the bandwidth on the data path network device (e.g., Infiniband, RoCE, or Ethernet) to determine if the network is saturated. This will cause “fake” failure events to load balance the networking traffic in the cluster.

Volume/LUN Monitor—This resource tracks a volume that is allocated storage capacity spanning one or more physical drives. The volume resource groups together the drives to force colocation on a single node. With single port drives, all volumes with be on the same node. With dual port drives, the volumes may be spread over two nodes.

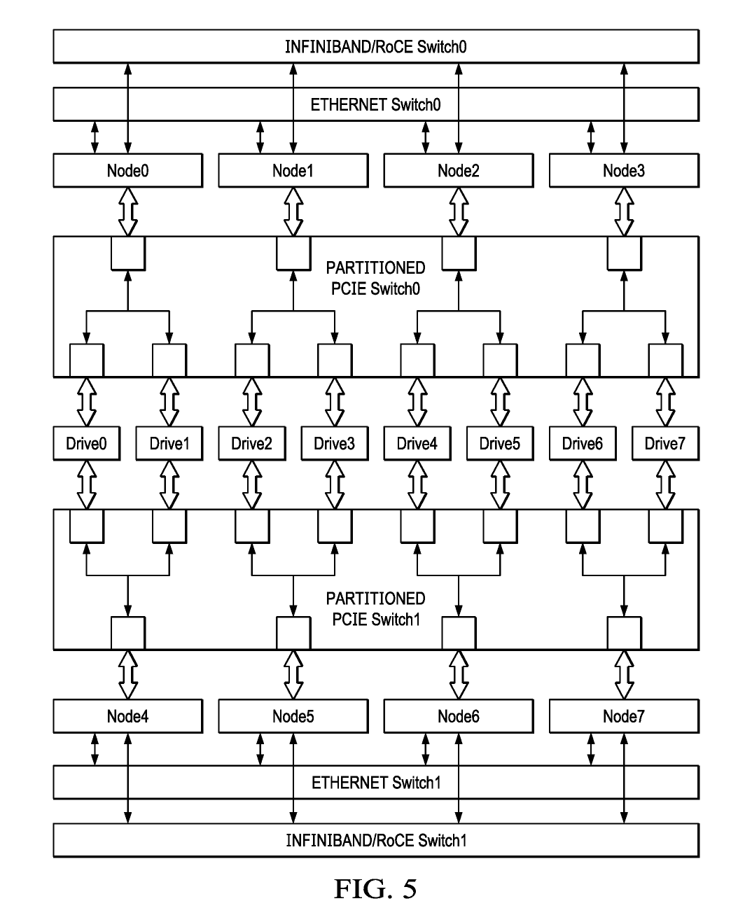

Partitioned Drive Port—Similar to the partitioned drive, this resource handles reprogramming one port of a dual port drive (e.g., as shown with respect to FIG. 5). Two of these resources are used to manage the independent ports of a dual ported drive.

Node Power Monitor—This resource will monitor performance for the entire cluster, consolidating resources on fewer nodes during low performance periods. This allows the plug-in to physically power off extra nodes in the cluster to conserve power when the performance isn't required. For example, all but one node may be powered off during idle times.

Network Path Monitor—This resource monitors communication from a node to an NVMeoF Initiator Endpoint that is accessing the data. This network path may fail due to faults outside of the target cluster. Networking faults may be handled by initiating a failure event to move drive ownership to another cluster node with a separate network path to the initiator. This allows fault tolerance in the network switches and initiator network cards.

Storage Software Monitor—The software that bridges NVMeoF to NVMe drives may crash or deadlock. This resource monitors that a healthy software stack is still able to process data.

Cache Monitor—This resource monitors other (e.g., non-NVMe) hardware devices, such as NV-DIMM drives that are used for caching data. These devices may be monitored to predict the reliability of the components, such as the battery or capacitor, and cause the node to shutdown gracefully before a catastrophic error.

Accordingly, the resource manager 204 may monitor the resources (for which it is configured to monitor in the cluster configuration 206) by calling a monitor interface of a corresponding resource plug-in 212 and identifying the resource (e.g., using the resource identifier). This monitor may be called, for example, at a regular interval. The resource plug-in 212 may then attempt to ascertain the status of the identified resource. This determination may include, for example, “touching” or attempting to access the resource (e.g., touching a drive, accessing a volume or LUN, etc.). If the storage resource cannot be accessed, or an error is returned in response to an attempted access, this storage resource may be deemed to be in a failed state. Any failures of those resources may then be reported or returned from the resource plug-ins 212 back to the resource manager 204. As another example, this determination may include, for example, ascertaining a data rate (e.g., data transfer rate, response time, etc.) associated with the storage resource. The data rate of those resources may then be reported or returned from the resource plug-ins 212 back to the resource manager 204.

The current status of the resources of the cluster maintained by the resource manager 204 can then be updated. The policy engine 208 can utilize this current state of the cluster and the cluster configuration to determine which, if any, resource should be reassigned to a different node. Specifically, the policy engine 208 may determine whether the state of the cluster has changed (e.g., if a storage resource has failed) and a next state of the cluster based on the current state and the configuration. If the cluster is to transition to a next state, the policy engine 208 may produce a transition graph containing a list of actions and dependencies.

If these actions entail that a resource be reassigned to a different node, the resource manager 204 may call an interface of the resource plug-in 212 corresponding to the type of resource that needs to be reassigned or moved. The call may identify at least the resource and the node to which the resource should be assigned. This call may, for example, be a start call or a migrate-to or migrate-from call to the resource plug-in 212. The resource plug-in 212 may implement the call from the resource manager 204 by, for example, programming the switch of the cluster to assign the identified storage resource to a virtual switch partition of the switch associated with the identified node.

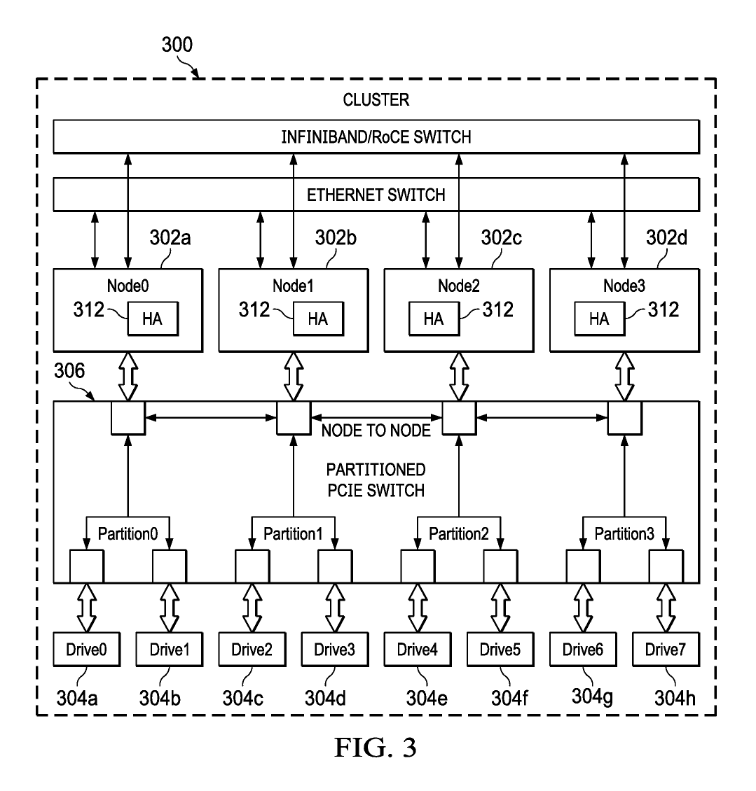

It may now be useful to illustrate specific examples of the dynamic reassignment of storage resources and reconfiguration of a cluster by reprogramming of a PCIe switch (and partitions thereon) to increase the availability of storage resources within a cluster. Referring then to FIG. 3, a healthy cluster 300 of four computer nodes 302 with single ported NVMe drives 304 connected to a partitioned PCIe switch 306 is shown. The cluster may communicate on three paths: Ethernet, Infiniband/RoCE, or PCIe Node to Node links. In this example, the PCI Express switch 306 is partitioned so Node0 302a sees only Drive0 304a and Drive1 304b, Node1 302b sees only Drive2 304c and Drive3 304d, Node2 302c sees only Drive4 304e and Drive5 304f and Node3 302d sees only Drive6 304g and Drive1 304h.

In particular, the cluster as shown in FIG. 3 is composed of multiple nodes 302 up to the number of virtual switch partitions supported by the PCIe switch 306. This may be, for example from 2 to 16 nodes. The cluster 300 implements an N-to-N redundancy model, where all cluster resources may be redistributed over any remaining active nodes 302. Only a single node 302 is required to be active to manage all the drives 304 on the switch 306, while all other nodes 302 may be offline. This increased redundancy provides resilience to multiple failures and reduces unnecessary hardware node cost for unlikely failure conditions.

The nodes 302 are joined in the cluster 300 using a distributed software state machine maintained by a high-availability module 312 on the nodes 302 to maintain a global cluster state that is available to all nodes. The cluster state machine in the high-availability module 312 maintains the cluster node membership and health status. It provides a consistent configuration storage for all nodes 302, providing details of the cluster resources such as NVMe drives. It schedules each drive 304 to be activated on a given node 302 to balance the storage and networking throughput of the cluster 300. It monitors the health of drive resources, software processes, and the hardware node itself. Finally, it handles both failover and failback events for individual resources and entire nodes when failures occur.

The cluster 300 (e.g., the high-availability modules 312 on each node 302 or other entities in the cluster 312) communicates via unicast or multicast messages over any Ethernet, Infiniband or PCI Express (Node to Node) network as shown. The messages may, or may not, use the PCIE switch itself for transmission, which allows multiple, active paths for the nodes 302 (or HA module 312 on each node 302) to communicate. This multi-path cluster topology is a clear advantage over existing models that use only a PCI Express non-transparent bridge for communication, since there is no single point of failure in the cluster communication. Even if a node 302 loses access to the PCI Express switch 306 and the corresponding drive resources, it may still communicate this failure to the remaining nodes 302 via a network message to quickly initiate a failover event.

By using a software cluster state machine with distributed resource management in HA module 312 on each node 302, much more control over failures may be provided. This state machine (e.g., the configuration and rules defined in the resource manager of the HA module 312, along with a current status of the cluster 300) allows higher node count clusters, maintaining the concept of a cluster quorum to prevent corruption when communication partially fails between nodes. The resource monitoring of the HA modules 312 inspects all software components and hardware resources in the cluster 300, detecting hardware errors, software crashes, and deadlock scenarios that prevent input/output (I/O) operations from completing. The state machine may control failover operations for individual drives and storage clients for a multitude of reasons, including the reprogramming of switch 306 to assign drives 304 to different partitions associated with different nodes 302. Failure to access the drive hardware may be a primary failover reason. Others may include, but are not limited to, lost network connectivity between the node and remote clients, performance load balancing among nodes, deadlocked I/O operations, and grouping of common resources on a single node for higher level RAID algorithms. This ability to balance resources individually is a key differentiator over existing solutions.

Embodiments of the cluster design described in this disclosure may thus utilize virtually partitioned PCIe switches to effectively move single ported PCIe drives from one node to another. By combining a distributed cluster state machine to control a flexible PCIe switch, the cluster's high-availability is improved while using lower cost hardware components.

It will be noted that embodiments of the same cluster model as described can be extended to use dual port NVMe drives as well, where each port of the drive is attached to a separate partitioned PCIe switch 306 (e.g., as shown in FIG. 3). In these embodiments, the cluster state machine manages each port of the drive as a separate resource, reprogramming the switch on either port for failover events. This effectively creates a separate intelligent cluster for each port of the dual port drive, offering the same benefits discussed earlier, such as high node count with N-to-N redundancy and flexible resource management for failures and load balancing.

It may now be helpful to an understanding of embodiments to discuss the configuration of high availability module 312 of cluster 300. The NVMeoF cluster 300 may require a configuration corresponding to the underlying hardware platform. The information about the available programmable interfaces (such as partitioned PCIe switch models), drive locations (such as slots and PCIe switch port locations), and other behaviors are listed in a platform configuration file.

The following example walks through creating the cluster configuration in FIG. 3. First the cluster configuration file may be loaded in to the high-availability module 312. This may include identifying which node 302 is currently running and mapping to a node index in the cluster configuration file. The cluster configuration file and node index can be used to identify which PCIe switches 306 exist. Any software modules for programming PCIe switches 306 may be loaded. This may include resource plug-ins or the like for HA module 312. All hardware resources of the cluster may then be assigned to the current node. Newly assigned drives will be “hotplugged” into the cluster and detected by the HA module 312.

The HA module 312 can then detect which NVMe drives are installed, as some PCIe slots may be empty. The next step is to map the PCIe slot and switch port (from the configuration file) to the installed PCI address (from the hardware device scan), to the drive GUID stored (from the storage software stack scan).

At this point, abstract cluster resources to manage the drives may be created based on the above mapping. This entails the creation of the resources in the configuration file of the HA module 312. In particular, the creation of these resources may include creating a drive resource with a type specified in configuration file (such as Partitioned Drive vs Performance Drive Monitor) and the creation of a co-location requirement between the storage software resource and each drive. For example, failure of the storage software of HA module 312 (e.g., on a node), should fail all drives (e.g., on a partition associated with that node).

The creation of cluster resources may also include the creation of an ordering requirement in the configuration file, where the storage software starts before each drive and the creation of a set of preferred node weights in the configuration file for the drives 304. For example, using the illustrated example, the node weights may be: Drive0-N0, N2, N1, N3 [indicating Node 0 is highest preference, so it has the highest weight, while Node3 is the lowest preference]; Drive1—N0, N3, N2, N1; Drive2—N1, N3, N2, NO; Drive3—N1, N0, N3, N2; Drive4—N2, N0, N3, N1; Drive5—N2, N1, N0, N3; Drive6—N3, N1, N0, N2; and Drive1—N3, N2, N1, NO.

The monitoring interval for each drive 304 can then be set in the configuration file (e.g., 10-30 seconds with 30 second timeout). The failover can then be set of the storage resources. For example, a drive resource can be set to failover to another node on the first monitoring failure. The resources in the configuration file can then be configured with all corresponding identifiers (e.g., the drive identifiers: GUID, PCIe Slot, Switch Port). This allows monitoring the resource from the storage stack and HA module 312 and reprogramming the connected PCIe switch 306. Then, networking monitoring resources can be created and defined in the configuration file for the HA module 312.

At this point, node1 302b, node2 302c, and node3 302d can be added to the cluster 300. These nodes 302 will inherit the configuration already done on node0 302a by virtue of the communication between the cluster manager or resource manager of the high-availability modules 312 on each node 302. Resources of the cluster will automatically be rebalanced by HA module 312 (e.g., by reconfiguration of the switch 306 through resource plug-ins) based on the configured preferred node weights.

Thus, in one embodiment, in a healthy state of operation, the cluster in FIG. 3 performs the following. Each node 302 (e.g., the HA module 312 on each node 302) broadcasts a health check. This indicates if the node 302 is alive and communicating on the cluster. Such a check may not be related to the resource health. The software stack resource (e.g., the HA module 312) monitors for a crash or deadlock by issuing health check commands that use the data path for data in the cluster 300. The HA module 312 uses configured drive resources to monitor the drives 304 by issuing commands to the plug-ins of the HA module 312. The commands will typically access the drive 304 via the PCIe interface of PCIe switch 306 to ensure communication is working. The HA module 312 may utilize any configured performance resources to query the data rates from the storage stack to monitor the performance of the drives 304 or the switch 306. The HA module 312 may use a configured networking resource to detect either local faults (e.g., by using network configuration tools in the OS such as Linux), or failed routes to an initiator by sending network packets (e.g., using ping or arp).

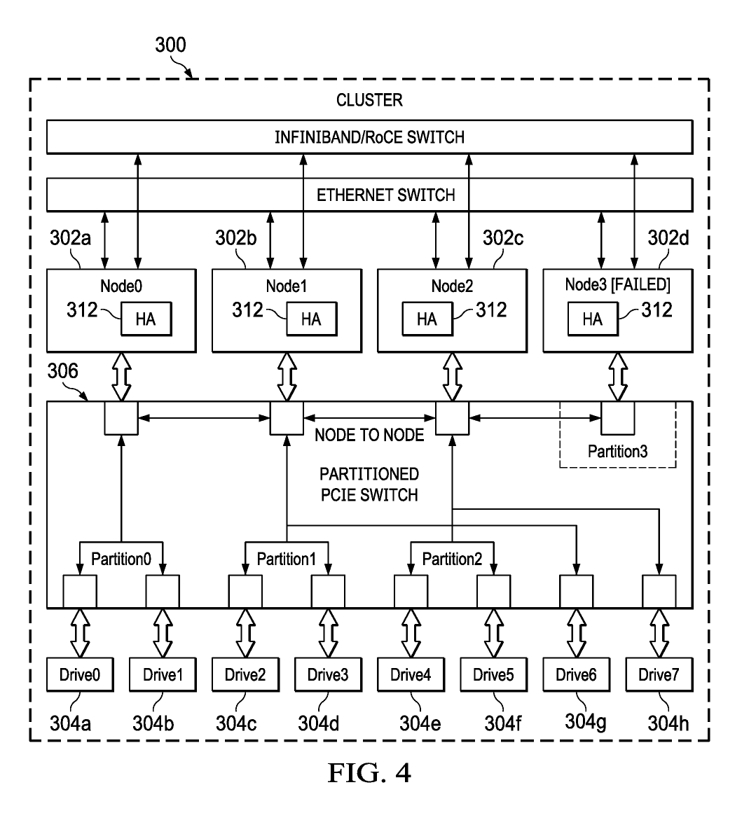

Moving now to FIG. 4, a depiction of the cluster 300 of FIG. 3 with one failed node (302d), showing the PCI Express Switch 306 reconfigured to attach Drive6 304g to Node1 302b and Drive7 304h to Node2 302c. Here, if a failure is reported for a resource from a monitoring activity (e.g., a monitor call to the resource plug-in for the resource, the HA module 312 will utilize the configuration rules (e.g., the state machine) along with the current status of the cluster 300 to restore the high-availability services.

For example, consider an example where the storage stack fails on Node3 302c as shown in FIG. 4. The following occurs: the storage stack monitor in a HA module 312 on a node 302 reports a failure. Node3 302c cluster software (e.g., the HA module 312) will report it is offline to all nodes 302. Node3 302c will stop all of its resources, including the network monitors, drive resources, and storage stack. These operations may fail, depending on the failure. Each other node 302 (E.g., the HA module 312 on the other nodes 302) will look at the resources that require failover, including Drive6 304g and Drive7 304h.

At this point, Node2 302b (e.g., the HA module 312 on Node 302b) will claim ownership of Drive7 304h, since it is the second highest preference as configured in the configuration of HA module 312. By claiming ownership, HA 312 on Node2 302b will invoke the start operation on Node2 302b (e.g., calling the resource plug-in for the resource configured to represent drive7 304h in the configuration file of HA module 312). This start call by the HA module 312 on Node2 302b will result in the HA module 312 (e.g., the called resource plug-in) reprogramming the PCIe switch 306 to move drive7 304h to Node2. Drive7 304h will be detected automatically in the storage stack as a hotplug event and the storage stack will connect Drive7 304h to a remote Initiator connection (if it exists) and Drive7 304h will be immediately available for I/O. In the example illustrated, Node1 302a (e.g., the HA module 312 on Node1 302a) will claim ownership of Drive6 304g with a similar process.

As mentioned, embodiments of the same cluster model as described can be extended to use dual port NVMe drives as well, where each port of the drive is attached to a separate partitioned PCIe switch. In these embodiments, the cluster state machine manages each port of the drive as a separate resource, reprogramming the switch on either port for failover events. This effectively creates a separate intelligent cluster for each port of the dual port drive, offering the same benefits discussed earlier, such as high node count with N-to-N redundancy and flexible resource management for failures and load balancing.

FIG. 5 depicts an example of just such an embodiment, Here, an eight node cluster with dual ported drives that each connect to two PCIe switches is depicted. During normal use both ports may be active, for example, allowing Drive0 to be accessed from Node0 and Node4. Each port can failover to another node on the same PCIe switch. For example, if Node0 fails, Node 1-3 may take over the PCIe port.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

One embodiment can include one or more computers communicatively coupled to a network. As is known to those skilled in the art, the computer can include a central processing unit (“CPU”), at least one read-only memory (“ROM”), at least one random access memory (“RAM”), at least one hard drive (“HD”), and one or more I/O device(s). The I/O devices can include a keyboard, monitor, printer, electronic pointing device (such as a mouse, trackball, stylus, etc.), or the like. In various embodiments, the computer has access to at least one database over the network.

ROM, RAM, and HD are computer memories for storing computer-executable instructions executable by the CPU. Within this disclosure, the term “computer-readable medium” is not limited to ROM, RAM, and HD and can include any type of data storage medium that can be read by a processor. In some embodiments, a computer-readable medium may refer to a data cartridge, a data backup magnetic tape, a floppy diskette, a flash memory drive, an optical data storage drive, a CD-ROM, ROM, RAM, HD, or the like.

At least portions of the functionalities or processes described herein can be implemented in suitable computer-executable instructions. The computer-executable instructions may be stored as software code components or modules on one or more computer readable media (such as non-volatile memories, volatile memories, DASD arrays, magnetic tapes, floppy diskettes, hard drives, optical storage devices, etc. or any other appropriate computer-readable medium or storage device). In one embodiment, the computer-executable instructions may include lines of compiled C++, Java, HTML, or any other programming or scripting code.

Additionally, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example”, “for instance”, “e.g.”, “in one embodiment”.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all of the claims.

What is claimed is:

1. A high availability (HA) storage cluster, comprising
a switch;
a set of storage resources coupled to a set of hosts and coupled to the switch via a first network; and
a set of nodes coupled via a second network to the switch, each node including an HA module thereon, the HA modules at each of the set of nodes cooperating to maintain a state for the HA storage cluster,
each HA module at each node maintaining the state of the HA cluster by communicating with each of the other HA modules to synchronize the state maintained at each of the other HA modules with the state maintained at the HA module at that node and a state machine for the HA cluster, wherein the state includes an association between each of the resources and a corresponding one of the set of nodes wherein an HA module at a first node is adapted for:
monitoring resources of the HA storage cluster;
detecting a failure in a resource of a storage cluster;
accessing the state maintained at the first node to determine that the switch is programmed such that the failed resource is assigned to a partition of the switch associated with the failed resource;
determining a second node to which the failed resource should be assigned based on the state machine of the HA module at the first node and the state maintained at the first node; and
reprogramming, by the HA module at the first node, the switch such that the switch is reconfigured to assign the storage resource and the second node to a same virtual switch partition

2. The system of claim 1, wherein the resources include the switch, the set of nodes, the set of storage resources, a volume, a Logical Unit Number (LUN) or a network path.

3. The system of claim 1, wherein monitoring resources includes attempting to access the resources at a time interval.

4. The system of claim 1, wherein monitoring resources includes communicating a heartbeat message between each HA module.

5. The system of claim 1, wherein the failure is a bandwidth or data rate associated with the resource falling below a certain threshold level.

6. The system of claim 1, wherein the first network and the second network are the same network.

7. The system of claim 1, wherein the switch is a PCI Express switch.

8. A method for operating a high availability (HA) storage cluster, comprising
providing a set of HA modules at a set of nodes of an HA storage cluster, the HA storage cluster including a set of storage resources coupled to a set of hosts and coupled to a switch via a first network, wherein the set of nodes are coupled via a second network to the switch;
cooperating between the HA module at the set of nodes to maintain a state for the HA storage cluster, each HA module at each node maintaining the state of the HA cluster by communicating with each of the other HA modules to synchronize the state maintained at each of the other HA modules with the state maintained at the HA module at that node and a state machine for the HA cluster, wherein the state includes an association between each of the resources and a corresponding one of the set of nodes, and at an HA module of a first node:
monitoring resources of the HA storage cluster;
detecting a failure in a resource of a storage cluster;
accessing the state maintained at the first node to determine that the switch is programmed such that the failed resource is assigned to a partition of the switch associated with the failed resource;
determining a second node to which the failed resource should be assigned based on the state machine of the HA module at the first node and the state maintained at the first node; and
reprogramming, by the HA module at the first node, the switch such that the switch is reconfigured to assign the storage resource and the second node to a same virtual switch partition

9. The method of claim 8, wherein the resources include the switch, the set of nodes, the set of storage resources, a volume, a Logical Unit Number (LUN) or a network path.

10. The method of claim 8, wherein monitoring resources includes attempting to access the resources at a time interval.

11. The method of claim 8, wherein monitoring resources includes communicating a heartbeat message between each HA module.

12. The method of claim 8, wherein the failure is a bandwidth or data rate associated with the resource falling below a certain threshold level.

13. The method of claim 8, wherein the first network and the second network are the same network.

14. The method of claim 8, wherein the switch is a PCI Express switch.

15. A non-transitory computer readable medium comprising instruction for:
providing a set of HA modules at a set of nodes of an HA storage cluster, the HA storage cluster including a set of storage resources coupled to a set of hosts and coupled to a switch via a first network, wherein the set of nodes are coupled via a second network to the switch;
cooperating between the HA module at the set of nodes to maintain a state for the HA storage cluster, each HA module at each node maintaining the state of the HA cluster by communicating with each of the other HA modules to synchronize the state maintained at each of the other HA modules with the state maintained at the HA module at that node and a state machine for the HA cluster, wherein the state includes an association between each of the resources and a corresponding one of the set of nodes, and at an HA module of a first node:
monitoring resources of the HA storage cluster;
detecting a failure in a resource of a storage cluster;
accessing the state maintained at the first node to determine that the switch is programmed such that the failed resource is assigned to a partition of the switch associated with the failed resource;
determining a second node to which the failed resource should be assigned based on the state machine of the HA module at the first node and the state maintained at the first node; and
reprogramming, by the HA module at the first node, the switch such that the switch is reconfigured to assign the storage resource and the second node to a same virtual switch partition

16. The non-transitory computer readable medium of claim 15, wherein the resources include the switch, the set of nodes, the set of storage resources, a volume, a Logical Unit Number (LUN) or a network path.

17. The non-transitory computer readable medium of claim 15, wherein monitoring resources includes attempting to access the resources at a time interval.

18. The non-transitory computer readable medium of claim 15, wherein monitoring resources includes communicating a heartbeat message between each HA module.

19. The non-transitory computer readable medium of claim 15, wherein the failure is a bandwidth or data rate associated with the resource falling below a certain threshold level.

20. The non-transitory computer readable medium of claim 15, wherein the first network and the second network are the same network.

21. The non-transitory computer readable medium of claim 15, wherein the switch is a PCI Express switch.
